(19) United States
(12) Patent Application Publication
(10) Pub. No.: US 2023/0356644 A1
(43) Pub. Date: Nov. 9, 2023

(54) SMALL WATERCRAFT AND SIMILARLY SIZED ARTICLE TRANSPORT DEVICE AND METHOD

(71) Applicant: Ketch Products, Inc., East Dundee, IL (US)

(72) Inventor: Robert Weskamp, Barrington Hills, IL (US)

(21) Appl. No.: 17/737,444

(22) Filed: May 5, 2022

(51) Int. Cl. B60P 3/10

(52) U.S. Cl. CPC B60P 3/1066

(57) ABSTRACT

An article transport device including a wheelbase assembly and an article support assembly. The article support assembly includes a telescopic member that acts as a kickstand to unable one person loading of the article upon the transport. The wheelbase is modular in design to enable exchange of the article support assembly of differing configurations.

### CROSS-REFERENCE TO RELATED APPLICATION

### Background of the Invention

### I. Field of the Invention

The present disclosure relates generally to devices for transporting personal aquatic vessels and similarly sized articles, and more specifically to a cart with a telescopic extension to facilitate individual loading and unloading of small watercrafts such as kayaks and canoes.

### II. DESCRIPTION OF THE PRIOR ART

Small recreational watercrafts such as kayaks, canoes, small boats, dinghies, zodiacs and the like use over-the-road portable and detachable transport systems for the transportation of the watercraft on highways and roads to the water area for launching of the watercraft, as well as, the recovery of the watercraft from that water area after use has been completed. Typically, these transport systems have only intermittent use as they are constructed for long haul transporting on roads and are not usually suitable for portage.

Kayaking and canoeing, for example, often require portage over beach, sand, trail or other such rough terrain. Additionally, the vessel is often loaded with camping, fishing and/or other watercraft gear. Indeed, kayakers expend much energy with transport issues that it typically limits their enjoyment on the water and the amount of time they can spend kayaking. Without a so-called portage transport, such portages are often very difficult and tiresome or perhaps even virtually impossible for a single person.

As such, there have been numerous prior art portage transport designs to aid the traverse from the over-the-road transport system, over the rough terrain or beach sand, to a water area (river, lake, pond, stream, ocean, etc.). However, there have been a number of problems related to the main types of portage carts. For example, one source of problem concerns the way the cart is secured to the watercraft to attempt to provide stability through disruptive terrain. Another source of problems concerns the positioning of the watercraft on the cart. Additionally, there has been focus on unique constructions of substantial framing or a supportive unit intended to support the weight of the watercraft, as well as adjustably accommodating for a variety of sizes.

While these numerous designs have arguably addressed some of the issues, there nevertheless remains an issue of individual loading and unloading of watercraft and transport device. Accordingly, there remains a need for a watercraft transport design that is particularly suited for individual loading and unloading of the craft. The present disclosure overcomes the problems with conventional devices and fulfills this need. Accordingly, it is a general object of this disclosure to provide an improved small watercraft transport device.

It is another general object of the present disclosure to provide a watercraft transport device that can be loaded and unloaded by an individual.

It is a more specific object of the present disclosure to provide a small watercraft transport with a telescopic extension to better position the craft for loading and unloading.

Another object of the present disclosure is to provide a modular design to accommodate interchangeable attachments about a common wheelbase.

Yet another object pf the present disclosure is to provide a flat deck, canvas trough and J-hook attachment to the common wheelbase.

These and other objects, features and advantages of this disclosure will be clearly understood through a consideration of the following detailed description.

### SUMMARY OF THE INVENTION

According to an embodiment of the present disclosure, there is provided a device for transporting articles having a wheelbase assembly and an article assembly. The wheelbase assembly includes a frame and at least two wheels and the article assembly includes at least two article support members. At least one of the members having an internal telescoping section for positioning the device for article loading.

According to another embodiment of the present disclosure, there is provided a method for transporting an article by placing an article transporting device on an underlying support surface, extending a telescoping section from the device for positioning thereof for loading of the article thereon, lifting one end of the article and positioning same over the device, lowering the article onto the device and transporting the article with the device.

### BRIEF DESCRIPTION OF THE DRAWINGS

The present disclosure will be more fully understood by reference to the following detailed description of one or more preferred embodiments when read in conjunction with the accompanying drawings, in which like reference characters refer to like parts throughout the views and in which:

FIG. 1 is a perspective view of the small watercraft transport device according to the principles of an embodiment of the present disclosure.

FIG. 2 is a perspective view of the device of FIG. 1 with the telescoping support in an extended position.

FIG. 3 is a perspective view of the device of FIG. 2 in a watercraft receiving position.

FIG. 4 is a perspective view of the design of FIG. 3 adjacent a watercraft.

FIG. 5 is a perspective view of the device and watercraft of FIG. 4 as a user positions the watercraft over the device.

FIG. 6 is a perspective view of the device and watercraft of FIG. 5 after positioning.

FIG. 7 is a perspective view of the device and watercraft of FIG. 6 during transport.

FIG. 8 is a reduced perspective view of the device of FIG. 1.

FIG. 9 is a semi-exploded perspective view of the flat deck attachment according to the principles of an alternate embodiment of the present disclosure.

FIG. 10 is a semi-exploded perspective view of the canvas trough attachment according to the principles of an alternate embodiment of the present disclosure.

FIG. 11 is a perspective view of the embodiment of FIG. 9 in use.

FIG. 12 is a perspective view of the embodiment of FIG. 10 in use.

FIG. 13 is a side view of an alternate embodiment of FIG. 10.

FIG. 14 is a perspective view of an embodiment of FIG. 13.

FIG. 15 is a perspective view of an embodiment of FIG. 13.

### DESCRIPTION OF THE PREFERRED EMBODIMENTS

One or more embodiments of the subject disclosure will now be described with the aid of numerous drawings. Unless otherwise indicated, use of specific terms will be understood to include multiple versions and forms thereof.

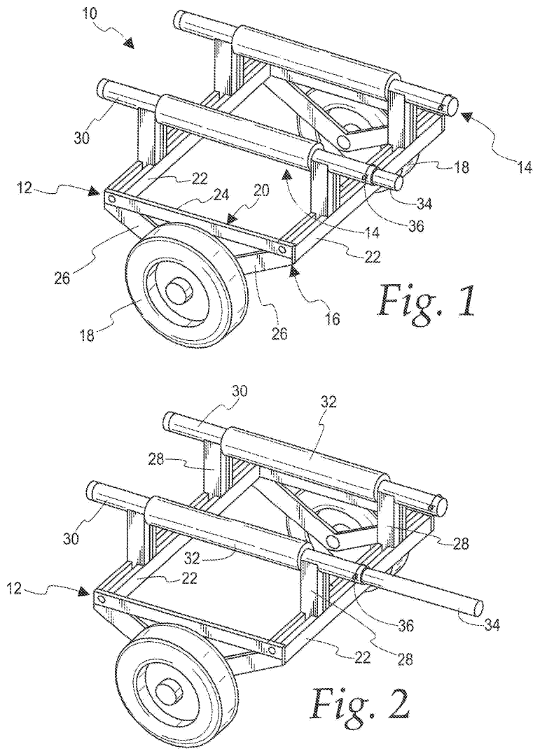

Turning now to the figures, and in particular FIGS. 1 and 2, an embodiment of the portage transport device 10 is illustrated in the perspective view. The main component parts of the base model of the device 10 includes a common wheelbase assembly 12 and two fully adjustable watercraft support assemblies, or so-called bunks 14. The wheelbase assembly 12 has a frame 16 and two wheels attached thereto. The frame has a pair of strut assemblies 20 secured together in laterally spaced-apart relation by a pair of cross bar assemblies 22. The strut assemblies 20 have an upper member 24 and a pair of diagonal braces 26 that converge from the upper member 24 to a wheel axle (not shown).

The watercraft support assemblies 14 have a pair of vertical support members 28 adjustably coupled to the cross bars 22 and supporting the horizontal watercraft support members 30. This adjustability may be preferably of a T-track configuration, although any suitable adjustable coupling will suffice. The support members 30 can be covered in a foam material 32 known in the art. In the preferred embodiment, the material 32 covering the support members 30 has a surface texture that is configured to provide a gripping effect on the watercraft to aid in preventing same from sliding off the support members.

At least one of the support members 30 includes an internal telescoping support 34. This internal telescoping member 34 is shown in FIG. 1 in a stored or retracted position and within the support member 30, and in FIG. 2 in an extended position and out of the support member 30. A pin with clip (or the like) arrangement keeps the telescoping member 34 locked in the desired position. In particular, a clevis or preferably a double wire snap safety pin 36 engages cooperating holes 38 in both the support member 30 and the telescoping support 34. It is this telescoping feature that provides for easy solo loading of the watercraft upon the transport device 10.

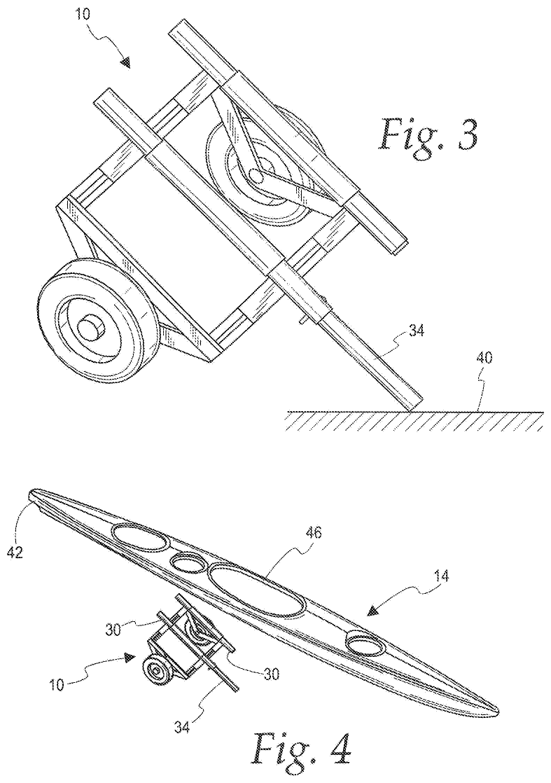

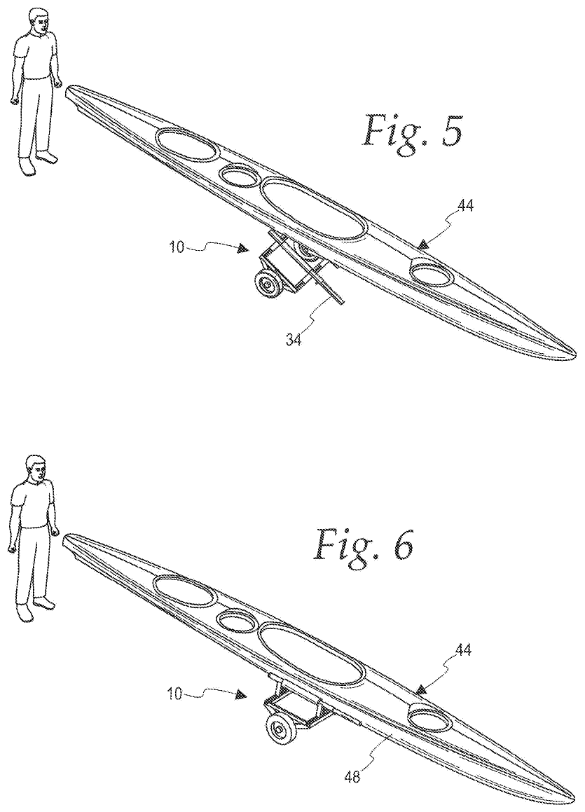

The device may be first fit to the watercraft. This may be best accomplished by flipping the watercraft over, turning the device upside-down and adjusting the support assemblies to fit the bottom of the watercraft. Once the adjustable support assemblies are fit to the specific watercraft, the device is ready for use. FIGS. 3-7 illustrate the use of this telescoping kick-stand type feature of the present disclosure. Turning first to FIG. 3, the transport device 10 is shown in a watercraft receiving position with the telescoping member 34 extended and resting upon an underlying support surface 40. This stabilizes and tilts the transport device 10 away from its stand (telescoping member) 34. As such, the user can easily lift one end 42 of the small watercraft 44 over the device to position a midpoint 46 thereof over the two support members 30, see FIGS. 4 and 5.

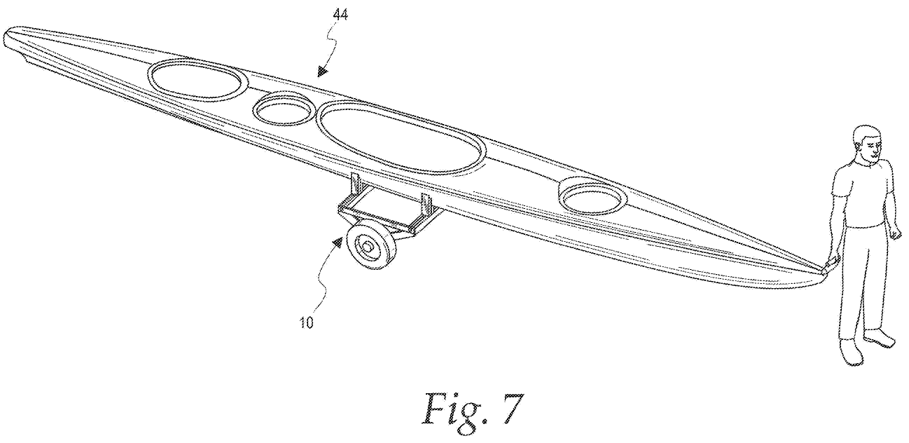

Upon lowering the watercraft upon the two support members 30 the transport device 10 tilts back up to match the angle of the watercraft hull 48. The user may then use tie down straps (or the like) before pushing (FIG. 6) and or pulling (FIG. 7) the watercraft 44 to the desired water area. The user then lifts one end 42 of the watercraft 44 and can easily unload and launch same.

The transport device 10 is made of light weight construction with the use of nuts, bolts, rivets, welding or the like. As such, once the watercraft 44 is launched, the device can fit into the watercraft and may be further designed to hold or store poles, tackle, etc. Accordingly, there is no worry of leaving the device 10 behind while enjoying the watercraft 44 on the water.

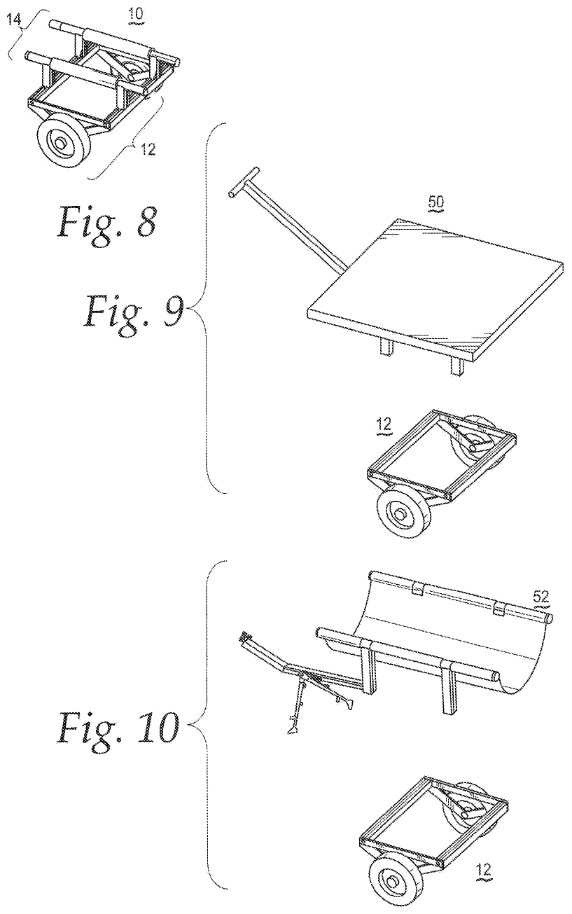

As previously noted, the preferred embodiment of the transport device 10 (now shown in FIG. 8) includes a common wheelbase assembly 12 and watercraft support assemblies 14. It will be appreciated that another feature of the current disclosure is the modularity thereof. In other words, that the common wheelbase 12 may be utilized with interchangeable attachments, including the aforementioned watercraft support assemblies 14.

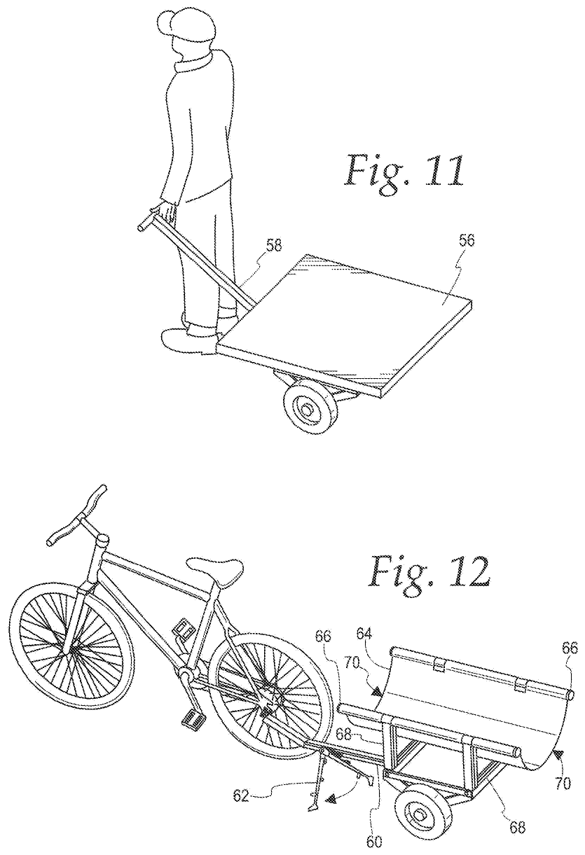

Examples of such attachments may include a flat deck assembly 50 (FIG. 9), and a canvas trough assembly 52 (FIG. 10). These attachments are modularly coupled to the common wheelbase assembly 12 and can be used to transport a plethora of articles. The flat deck or so-called all-purpose attachment 50 is shown in use in FIG. 11. In its most basic configuration, the all-purpose attachment includes a flat horizontal bed 56 fastened on top of the wheelbase assembly and a pull handle attachment 58 which may be fastened to the telescoping kickstand member of the wheelbase assembly or otherwise.

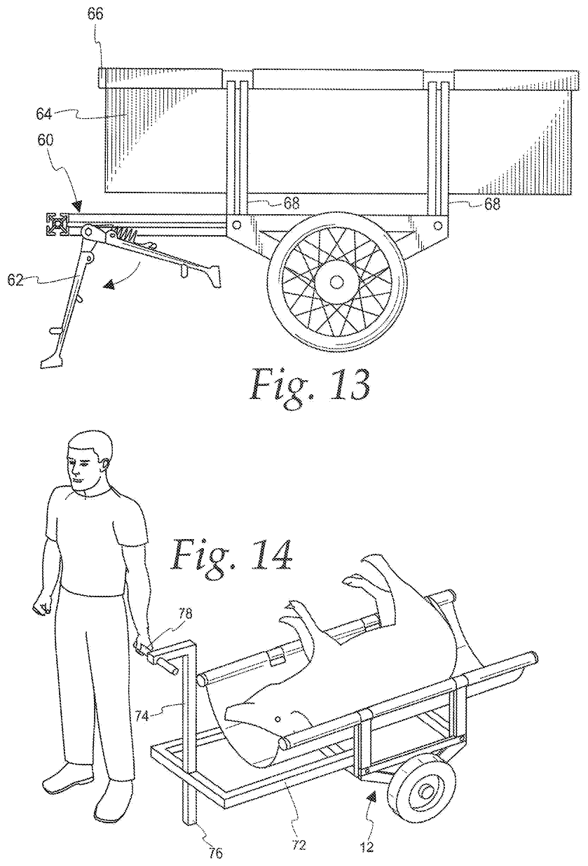

The trough assembly or so-called hunter attachment 52 is better shown in FIGS. 12-15. In particular, FIG. 12 illustrates a bicycle attachment 60 including a kickstand 62. It will be appreciated that the bicycle attachment 60 is standard in the art. Similarly, the attachment could be for a motorcycle, ATV, snowmobile or the like. In any event, the canvas sling 64 is attached to horizontal supports 66 on each side and when coupled to the vehicle support members 68 provides a trough like shape with open ends 70.

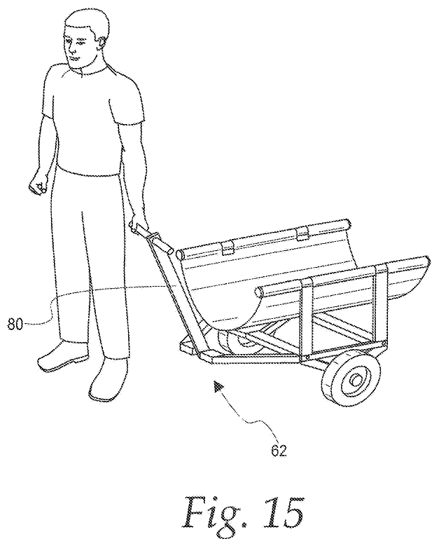

Alternatively, the hunter attachment (FIG. 14) may further include an elongated support assembly 72 fastened on one end to the wheelbase 12 and on the other end to a vertical stand 74 with an underlying support surface end 76 and a user engagement end 78. Yet another hunter attachment embodiment (FIG. 15) utilizes the kickstand 62 as previously discussed, and a hinged user handle member 80.

The foregoing detailed description has been given for clearness of understanding only and no unnecessary limitations should be understood therefrom. Accordingly, while one or more particular embodiments of the disclosure have been shown and described, it will be apparent to those skilled in the art that changes and modifications may be made therein without departing from the invention in its broader aspects, and, therefore, the aim in the appended claims is to cover all such changes and modifications as fall within the true spirit and scope of the present disclosure.

What is claimed is:

1. A device for transporting articles comprising:
a wheelbase assembly including a frame and at least two wheels;
an article assembly fastened to said wheelbase assembly and including at least two article support members; and
at least one of said support members includes an internal telescoping member having a retracted position and an extended position whereby said extended position positions said device for loading of said article.

2. The transporting device as defined in claim 1 wherein said article is a personal aquatic vessel.

3. The transporting device as defined in claim 1 wherein at least one of said article support members includes a gripping material.

4. The transporting device as defined in claim 1 wherein said at least one of said support members including said telescoping member further having a locking mechanism for locking a position of said member.

5. The transporting device as defined in claim 1 wherein said wheelbase is modular and capable of exchanging said article assembly for a second article assembly.

6. The transporting device as defined in claim 5 wherein said second article assembly is a flat deck assembly.

7. The transporting device as defined in claim 5 wherein said second article assembly is a trough assembly.

8. A method for transporting an article consisting of:
placing an article transportation device on an underlying support surface;
extending a telescoping section of said device for positioning of said device for loading of an article having two ends;
lifting one end of said article and positioning said article over said device;
lowering said article onto said device; and
transporting said article with said device.

9. The method for transporting as defined in claim 8 wherein said article is a personal aquatic vessel.

10. The method for transporting as defined in claim 9 further consisting of unloading said article and launching said article on a body of water.

11. The method for transporting as defined in claim 10 further consisting of storing said device on said article.

12. The method for transporting as defined in claim 11 further consisting of said device holding smaller articles.

13. The method for transporting as defined in claim 11 further consisting of fitting said device to said watercraft.
